(19) United States
(12) Patent Application Publication
(10) Pub. No.: US 2016/0359647 A1
(43) Pub. Date: Dec. 8, 2016

(54) SELECTIVE CODEWORD-TO-LAYER MAPPING FOR MIMO TRANSMISSIONS

(71) Applicant: Telefonaktiebolaget L M Ericsson (publ), Stockholm (SE)

(72) Inventors: Maomao Chen, Arlöv (SE); Fredrik Nordstrom, Lund (SE)

(21) Appl. No.: 14/911,677

(22) PCT Filed: Jan. 27, 2016
(86) PCT No.: PCT/EP2016/051638

§ 371 Date: Feb. 11, 2016

Related U.S. Application Data
(60) Provisional application No. 62/110,708, filed on Feb. 2, 2015.
(60) Provisional application No. 62/110,698, filed on Feb. 2, 2015.

(51) Int. Cl. H04L 25/03; H04B 7/06; H04B 7/04

(52) U.S. Cl. CPC H04L 25/03929; H04B 7/0417; H04B 7/0482; H04B 7/0632; H04B 7/0639

(57) ABSTRACT

A method in a network node of a cellular communications system for providing MIMO transmissions to a communication device in the cellular communications system is disclosed. The MIMO transmissions use P code words mapped onto Q MIMO layers, where P≧2 and Q>P. The method comprises mapping the code words for transmission to the communication device onto the MIMO layers according to a selected mapping scheme that has been selected among a plurality of available mapping schemes available for use for MIMO transmission of P code words over Q MIMO layers in the cellular communications system. A corresponding method for the communication device is also disclosed.

### TECHNICAL FIELD

The present application relates to mapping of codewords to layers in a multiple-input multiple output transmission system.

### BACKGROUND

Multiple-input multiple-output (MIMO) systems can significantly increase the data carrying capacity of wireless systems. For this reason, MIMO is an integral part of 3rd and 4th generation wireless systems. Multiple antennas for transmission and reception are used as advanced antenna technique for improving both user throughput and cell throughput and are key factors behind the high performance offered by Third Generation Partnership Project, Universal Mobile Telecommunication-Standard Long Term Evolution (3GPP UMTS LTE). Starting from Rel-10 up to 8 layers is supported. Related standardization documents include 3GPP TS 25.214 ver. 12.1.0, 3GPP TS 36.101 ver. 12.6.0, and 3GPP TS 36.211 ver. 12.4.0.

The MIMO technique uses a notation (M×N) to represent MIMO configuration in terms number of transmit (M) and receive antennas (N). Common MIMO configurations used or currently discussed for various technologies are: (2×1), (1×2), (2×2), (4×2), (8×2) and (2×4), (4×4), (8×4). The configurations represented by (2×1) and (1×2) are special cases of MIMO.

With 4 Rx a 4×4 MIMO system supports up to four layer spatial multiplexing. With 4 Rx AP (4 receiver antenna pairs) an 8×4 MIMO system with four layer spatial multiplexing is capable of utilizing both beam forming and diversity gain in maximum level. These layers can be combined through dynamic beam-forming and MIMO receiver processing to increase reliability and range. From a performance point of view the use of 4 Rx AP allows higher User Equipment (UE) data rates in a wide range of scenarios and improved receiver sensitivity in general. Depending on a target signal-to-noise ratio (SNR) region, the transmission scheme used in the eNodeB and the channel conditions, the peak throughput can be doubled compared to dual-layer multiplexing by virtue of additional diversity gain and/or multiplexing gain.

Note that terminology such as NodeB or eNodeB and UE should be considering non-limiting and does not imply a certain hierarchical relation between the two; in general the network node (NodeB) could be considered as device 1 and “UE” (the wireless communication device) device 2, and these two devices communicate with each other over some radio channel. Herein, we also focus on wireless transmissions in the downlink, but the described concepts are equally applicable in the uplink.

### Codeword to Layer Mapping in LTE System

In the context of an LTE system, the general physical channel processing for downlink (DL) is illustrated in FIG. 1 (Overview of physical channel processing).

For transmit diversity, the standard dictates that the layer mapping shall be done according to Table 1. There is only one codeword and the number of layers is equal to the number of antenna ports used for transmission of the physical channel. The notation x^{(l)}(i) denotes symbol i of layer l, the notation d^{(c)}(j) denotes symbol j of codeword c, the notation M^{(c)}_{symb} denotes the number of symbols in codeword c, and M^{layer}_{symb} denotes the number of symbols per layer.

TABLE 1
Codeword-to-layer mapping for transmit diversity

| Number of | Number of | Codeword-to-layer mapping | |
|---|---|---|---|
| layers | codewords | i = 0, 1, . . . , M_{symb}^{layer} − 1 | |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 4 | 1 | x⁽⁰⁾ (i) = d⁽⁰⁾ (4i) x⁽¹⁾ (i) = d⁽⁰⁾ (4i + 1) x⁽²⁾ (i) = d⁽⁰⁾ (4i + 2) x⁽³⁾ (i) = d⁽⁰⁾ (4i + 3) | ${M}_{symb}^{layer} = \{ \begin{matrix}{M}_{symb}^{( 0 )} / 4 & if {M}_{symb}^{( 0 )} mod 4 = 0 \\ ( {M}_{symb}^{( 0 )} + 2 ) / 4 & if {M}_{symb}^{( 0 )} mod 4 \neq 0\end{matrix}$ If M_{symb}⁽⁰⁾ mod4 ≠ 0 two null symbols shall be appended to d⁽⁰⁾ (M_{symb}⁽⁰⁾ − 1) |

For spatial multiplexing, multiple codewords can be mapped to multiple layers depending on the transmission rank scheduled by the eNodeB. In the LTE DL, a hybrid automatic repeat request (HARQ) process is operated for each codeword. Each HARQ process requires an acknowledgement/non-acknowledgement (ACK/NAK) feedback signaling on uplink. To reduce the uplink feedback overhead, only up to two codewords are transmitted even though more than two layers can be transmitted on downlink in a given subframe. The standard dictates that the layer mapping shall be done according to Table 2. The number of layers is less than or equal to the number of antenna ports used for transmission of the physical channel. The case of a single codeword mapped to multiple layers is only applicable when the number of cell-specific reference signals is four or when the number of UE-specific reference signals is two or larger.

TABLE 2
Codeword-to-layer mapping for spatial multiplexing

| | | Codeword-to-layer mapping | |
|---|---|---|---|
| Number of layers | Number of codewords | i = 0, 1, . . . , M_{symb}^{layer} − 1 | |
| 1 | 1 | x⁽⁰⁾ (i) = d⁽⁰⁾ (i) | M_{symb}^{layer} = M_{symb}⁽⁰⁾ |
| 2 | 1 | x⁽⁰⁾ (i) = d⁽⁰⁾ (2i) | M_{symb}^{layer} = M_{symb}⁽⁰⁾/2 |
| | | x⁽¹⁾ (i) = d⁽⁰⁾ (2i + 1) | |
| 2 | 2 | x⁽⁰⁾ (i) = d⁽⁰⁾ (i) | M_{symb}^{layer} = M_{symb}⁽⁰⁾ = M_{symb}⁽¹⁾ |
| | | x⁽¹⁾ (i) = d⁽¹⁾ (i) | |
| 3 | 1 | x⁽⁰⁾ (i) = d⁽⁰⁾ (3i) | M_{symb}^{layer} = M_{symb}⁽⁰⁾/3 |
| | | x⁽¹⁾ (i) = d⁽⁰⁾ (3i + 1) | |
| | | x⁽²⁾ (i) = d⁽⁰⁾ (3i + 2) | |
| 3 | 2 | x⁽⁰⁾ (i) = d⁽⁰⁾ (i) | M_{symb}^{layer} = M_{symb}⁽⁰⁾ = M_{symb}⁽¹⁾/2 |
| | | x⁽¹⁾ (i) = d⁽¹⁾ (2i) | |
| | | x⁽²⁾ (i) = d⁽¹⁾ (2i + 1) | |
| 4 | 1 | x⁽⁰⁾ (i) = d⁽⁰⁾ (4i) | M_{symb}^{layer} = M_{symb}⁽⁰⁾/4 |
| | | x⁽¹⁾ (i) = d⁽⁰⁾ (4i + 1) | |
| | | x⁽²⁾ (i) = d⁽⁰⁾ (4i + 2) | |
| | | x⁽³⁾ (i) = d⁽⁰⁾ (4i + 3) | |
| 4 | 2 | x⁽⁰⁾ (i) = d⁽⁰⁾ (2i) | M_{symb}^{layer} = M_{symb}⁽⁰⁾/2 = M_{symb}⁽¹⁾/2 |
| | | x⁽¹⁾ (i) = d⁽⁰⁾ (2i + 1) | |
| | | x⁽²⁾ (i) = d⁽¹⁾ (2i) | |
| | | x⁽³⁾ (i) = d⁽¹⁾ (2i + 1) | |
| 5 | 2 | x⁽⁰⁾ (i) = d⁽⁰⁾ (2i) | M_{symb}^{layer} = M_{symb}⁽⁰⁾/2 = M_{symb}⁽¹⁾/3 |
| | | x⁽¹⁾ (i) = d⁽⁰⁾ (2i + 1) | |
| | | x⁽²⁾ (i) = d⁽¹⁾ (3i) | |
| | | x⁽³⁾ (i) = d⁽¹⁾ (3i + 1) | |
| | | x⁽⁴⁾ (i) = d⁽¹⁾ (3i + 2) | |
| 6 | 2 | x⁽⁰⁾ (i) = d⁽⁰⁾ (3i) | M_{symb}^{layer} = M_{symb}⁽⁰⁾/3 = M_{symb}⁽¹⁾/3 |
| | | x⁽¹⁾ (i) = d⁽⁰⁾ (3i + 1) | |
| | | x⁽²⁾ (i) = d⁽⁰⁾ (3i + 2) | |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 2 | x⁽⁰⁾ (i) = d⁽⁰⁾ (3i) | M_{symb}^{layer} = M_{symb}⁽⁰⁾/3 = M_{symb}⁽¹⁾/4 |
| | | x⁽¹⁾ (i) = d⁽⁰⁾ (3i + 1) | |
| | | x⁽²⁾ (i) = d⁽⁰⁾ (3i + 2) | |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 3) | |
| 8 | 2 | x⁽⁰⁾ (i) = d⁽⁰⁾ (4i) | M_{symb}^{layer} = M_{symb}⁽⁰⁾/4 = M_{symb}⁽¹⁾/4 |
| | | x⁽¹⁾ (i) = d⁽⁰⁾ (4i + 1) | |
| | | x⁽²⁾ (i) = d⁽⁰⁾ (4i + 2) | |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

In the closed-loop spatial multiplexing mode, the eNodeB applies the spatial domain precoding on the transmitted signal taking into account the precoding matrix indicator (PMI) reported by the UE so that the transmitted signal matches with the spatial channel experienced by the UE. The closed-loop spatial multiplexing with M layers and N transmit antennas (N≧M). To support the closed-loop spatial multiplexing in the downlink, the UE typically needs to feedback the rank indicator (RI), the PMI, and the channel quality indicator (CQI) in the uplink as shown in FIG. 2 (Close loop spatial multiplexing). The RI indicates the number of spatial layers that can be supported by the current channel experienced at the UE. The eNodeB may decide the transmission rank, M, taking into account the RI reported by the UE as well as other factors such as traffic pattern, available transmission power, etc. The CQI feedback indicates a combination of modulation scheme and channel coding rate that the eNodeB should use to ensure that the block error probability experienced at the UE will not exceed 10%.

### Interference Cancellation Mechanism

For such systems, the optimal maximum-likelihood or Maximum A posteriori Probability (ML/MAP) detection for minimizing the packet error rate using exhaustive search is typically impossible to implement. This is because the MIMO detector's complexity increases exponentially with the number of layers or/and the number of bits per constellation point.

Several suboptimal detector structures have been proposed in literature for reducing the complexity of the MIMO detector. These can be classified as linear and nonlinear detectors. Linear detectors include zero-forcing (ZF) and minimum mean-square error (MMSE) detectors, and the nonlinear receivers include decision feedback, nulling-cancelling and variants relying on successive interference cancellation (SIC). These suboptimal detectors are easy to implement but their packet error rate performance is significantly inferior to that of the optimum MIMO detector. This is because most of these sub optimal detection techniques proposed in literature for cancelling multi antenna interference are proposed with/without channel coding and without utilizing the potential of cyclic redundancy check (CRC). However, in a practical system such as LTE/LTE-Advanced, Wimax, HSDPA (High Speed Downlink Packet Access) etc., the CRC bits are appended before the channel encoder at the transmitter and the check has been done after the channel decoder to know whether the packet is received correctly or not.

FIG. 3 (Multiple codeword MIMO transmitter) shows the transmission side of a MIMO communication system with Nₜ transmit antennas. There are N_{cw} transport blocks. CRC bits are added to each transport block and passed to the channel encoder. The channel encoder adds parity bits to protect the data. Then the stream is passed through an interleaver. The interleaver size is adaptively controlled by puncturing to increase the data rate. The adaptation is done by using the information from the feedback channel, for example channel state information sent by the receiver. The interleaved data is passed through a symbol mapper (modulator). The symbol mapper is also controlled by the adaptive controller. After modulation the streams are passed through a layer mapper and the precoder. The resultant streams are then passed through IFFT blocks. Note that the IFFT block is necessary for some communication systems which implements OFDMA as the access technology (for example LTE/LTE-A, Wi-max). For other systems which implements CDMA as the access technology (for example HSDPA etc.), this block is replaced by a spreading/scrambling block. The encoded stream is then transmitted through the respective antenna.

FIG. 4 (Multiple codeword MIMO receiver with interference cancellation) shows a MIMO receiver with interference cancellation, where all the receiver codewords are decoded at once. Once the CRC check is made on all the codewords, the codewords whose CRC is a pass are reconstructed and subtracted from the received signal and only those codewords whose CRC is a fail are decoded. This process is repeated till all the codewords are passed or all the codewords are failed or certain pre-determined number of iterations is reached.

Simulation Results with 2 and 4 Rx AP

With MIMO system with 4Rx AP the performance is improved in a straightforward way as shown in following.

System Level Gains with 4Rx AP

From system level the throughput performance for the mean user bit rate and 5% percentile cell edge user bit rate is shown for TM4 in FIG. 5 (System level results for TM4 based on practical IRC receiver) and for TM10 in FIG. 6 (System level results for TM10 based on practical IRC receiver).

With 2 layers and TM4 the system level performance of 4 Rx is boosted by 200% TP at medium served traffic (60 Mbps/sqkm) for both mean and 5% percentile user bit rate, cf. FIG. 5. For TM10 and 2 layers, cf. FIG. 6, the system level performance of 4 Rx is boosted by 166% TP for mean user bit rate and by 200% TP for 5% percentile user bit rate at medium served traffic (60 Mbps/sqkm).

Link Level Gains with 4Rx

The following link level results (in FIGS. 7-8 Link level results for TM4 with FRC (fixed reference channels) 16QAM code rate 1/2 under multi-cell scenario based on practical IRC/MRC receiver, 8-Link level results for TM4 with followed CQI under multi-cell scenario based on practical IRC/MRC receiver, and 9-Link level results for TM4 under single-cell scenario based on practical MRC receiver with FRC and follow CQI) are based on low channel correlation between antennas. The link level results in FIGS. 7 and 8 under multi-cell scenarios are based on the IRC scenario with TM4 on the serving cell and 2 interfering cells. FRC and followed CQI are used respective plots in FIG. 9 using practical MMSE-MRC (minimum mean square error, maximum ratio combining) or MMSE-IRC (minimum mean square error, interference rejection combining) receiver.

It may be observed that even with 2 layers on 4 Rx with diversity gain only the link level performance can be improved substantially: by 5 dB for MMSE-MRC receiver and 7 dB for MMSE-IRC receiver. With full rank as 4 layers with 4 Rx the peak TP (throughput) has boosted to double comparing to 2 layers with 2 Rx at high SINR range.

FIG. 9 shows the link level results for single cell scenario with TM4 based on FRC and followed CQI. With FRC test the results for 4 layers are worse than 2 layers at low SNR range. This is due to the fact that there is no link adaptation and hence a forced too high MCS on what the channel can handle. For 4 Rx antennas with 2 layers the diversity gain can still achieve up to 5 dB.

FIGS. 10 (Link level results for TM4 with single-cell scenario based on practical MMSE receiver with follow CQI under Xpol high EPA5) and 11 (Link level results for TM4 with single-cell scenario based on practical SU-MIMO receivers with follow CQI under Xpol high EPA5) illustrate the link level TP results for single cell scenario for different receivers with follow CQI under Xpol high on antenna configuration. FIG. 10 gives results for liner MMSE receiver and FIG. 11 is for SU-MIMO IC receivers as ML and CWIC. In FIG. 10 4×4 with 4 layers is included but it gives worse performance than 2 layer cases. This is due to high correlations between 2 sets of Xpol antennas so only 2 of the 4 layers are actually good enough to demodulate the data. But there are still good gain for 4 Rx AP with 2 layers up to 5 dB observed comparing to 2 Rx AP with 2 layers.

### Typical Antenna Configuration in Existing UE Devices

Some typical antenna configuration for LTE UE devices are shown in FIG. 12 (Typical antenna configurations for LTE UE devices with 2 Rx AP). The USB modem for computer is using Xpol (cross polarized), the mobile WiFi device is using ULA and the mobile phone device is using Xpol.

For devices with 4Rx AP some antenna configurations are shown in FIG. 13 (Typical antenna configurations for LTE UE devices with 4 Rx AP): ULA on the left and Xpol on the right.

The existing antenna configurations Uniform Linear Array (ULA) and Cross Polarized (Xpol) are also defined in 3GPP standardization in 3GPP TS 36.101 ver. 12.6.0. Table 3 gives the correlation parameters for ULA where alpha represents the correlation from eNodeB side and beta from UE side.

TABLE 3
Correlation parameters for ULA

| Low correlation | | Medium Correlation | | High Correlation | |
|---|---|---|---|---|---|
| α | β | α | β | α | β |
| 0 | 0 | 0.3 | 0.9 | 0.9 | 0.9 |

Table 4 gives the values for parameters α, β and γ for high spatial correlation for Xpol, where the alpha represents the correlation with in same pair of crossed polarized antennas from eNodeB side, beta represents the correlation with in same pair of crossed polarized antennas from UE side, while gamma represents the correlation between 2 pairs of crossed polarized antennas.

TABLE 4
Correlation parameters for Xpol high
High spatial correlation

| α | β | γ |
|---|---|---|
| 0.9 | 0.9 | 0.3 |

Note 1:
Value of α applies when more than one pair of cross-polarized antenna elements at eNB side.
Note 2:
Value of β applies when more than one pair of cross-polarized antenna elements at UE side.

### SUMMARY

The inventors have recognized that by, for a given number of codewords and a given number of layers, providing several alternative codeword to layer mappings, it is possible to more efficiently use the available channel capacity, compared with if a single fixed codeword to layer mapping is used for a given number of codewords and a given number of layers.

According to a first aspect, there is provided a method in a network node of a cellular communications system for providing multiple-input multiple-output (MIMO) transmissions to a communication device 1 in the cellular communications system. The MIMO transmissions use P code words mapped onto Q MIMO layers, where P≧2 and Q>P. The method comprises mapping the code words for transmission to the communication device onto the MIMO layers according to a selected mapping scheme that has been selected among a plurality of available mapping schemes available for use for MIMO transmission of P code words over Q MIMO layers in the cellular communications system.

The selected mapping scheme may be selected based on channel quality information for each of the layers.

The method may comprise selecting the selected mapping scheme based on said channel quality information for each of the layers.

The method may comprise receiving the channel quality information for each layer from the communication device.

The method may comprise receiving control information indicating the selected mapping scheme from another network entity, which has selected the selected mapping scheme.

The method may comprise receiving the channel quality information for each layer from the communication device, forwarding the channel quality information to another network entity, which is to perform the selection of the mapping scheme, and receiving control information indicating the selected mapping scheme from the other network entity.

In some embodiments, the channel quality information is indicative of a signal-to-interference-and-noise ratio (SINR) for each layer.

In some embodiments, P=2 and Q≧4.

According to a second aspect, there is provided a method in a communication device of a cellular communications network for reception of MIMO transmissions from a network node in the cellular communications system to the communication device. The MIMO transmissions use P code words mapped onto Q MIMO layers, where P≧2 and Q>P. The method comprises receiving control information indicating a selected mapping scheme that has been selected among a plurality of available mapping schemes available for use for MIMO transmission of P code words over Q MIMO layers in the cellular communications system. The method also comprises demapping code words from received MIMO layers according to the selected mapping scheme.

The selected mapping scheme may be selected based on channel quality information for each of the layers.

The method may comprise determining the channel quality information and transmitting the channel quality information to the network node to facilitate selection of the mapping scheme.

In some embodiments, the channel quality information is indicative of SINR for each layer.

According to a third aspect, there is provided a network node for a cellular communications system for providing MIMO transmissions to a communication device in the cellular communications system. The MIMO transmissions uses P code words mapped onto Q MIMO layers, where P≧2 and Q>P. The network node comprises a control unit. The control unit is adapted to map the code words for transmission to the communication device onto the MIMO layers according to a selected mapping scheme that has been selected among a plurality of available mapping schemes available for use for MIMO transmission of P code words over Q MIMO layers in the cellular communications system.

In some embodiments, the selected mapping scheme is selected based on channel quality information for each of the layers.

The control unit may be adapted to select the selected mapping scheme based on said channel quality information for each of the layers.

The control unit may be adapted to receive the channel quality information for each layer from the communication device.

The control unit may be adapted to receive control information indicating the selected mapping scheme from another network entity, which has selected the selected mapping scheme.

In some embodiments, the control unit is adapted to receive the channel quality information for each layer from the communication device, forward the channel quality information to another network entity, which is to perform the selection of the mapping scheme, and receive control information indicating the selected mapping scheme from the other network entity.

In some embodiments, the channel quality information is indicative of SINR for each layer.

In some embodiments, P=2 and Q≧4.

According to a fifth aspect, there is provided a communication device for reception of MIMO transmissions from a network node in a cellular communications system to the communication device. The MIMO transmissions use P code words mapped onto Q MIMO layers, where P≧2 and Q>P. The communication device comprises a control unit. The control unit is adapted to receive control information indicating a selected mapping scheme that has been selected among a plurality of available mapping schemes available for use for MIMO transmission of P code words over Q MIMO layers in the cellular communications system. The control unit is further adapted to demap code words from received MIMO layers according to the selected mapping scheme.

In some embodiments, the selected mapping scheme is selected based on channel quality information for each of the layers.

The control unit may be adapted to determine the channel quality information and transmit the channel quality information to the network node to facilitate selection of the mapping scheme.

In some embodiments, the channel quality information is indicative of SINR for each layer.

According to a sixth aspect, there is provided a computer program product comprising computer program code for executing the method according to the first aspect when said computer program code is executed by a programmable control unit of the network node.

According to a seventh aspect, there is provided a computer program product comprising computer program code for executing the method according to the second aspect when said computer program code is executed by a programmable control unit of the communication device.

According to an eighth aspect, there is provided a computer readable medium having stored thereon a computer program product comprising computer program code for executing the method according to the first aspect when said computer program code is executed by a programmable control unit of the network node.

According to a ninth aspect, there is provided a computer readable medium having stored thereon a computer program product comprising computer program code for executing the method according to the second aspect when said computer program code is executed by a programmable control unit of the communication device.

### BRIEF DESCRIPTION OF THE DRAWINGS

FIGS. 1-4 show block diagrams for explaining MIMO operation.

FIGS. 5-11 are plots showing performance simulation results for various types of MIMO operation.

FIGS. 12-13 illustrate example of physical antenna placement in various MIMO devices.

FIG. 14 illustrates a communication environment.

FIGS. 15-16 are flowcharts for methods.

FIG. 17 is a block diagram of a network node.

FIG. 18 illustrates a computer-readable medium and a programmable control unit.

FIG. 19 is a block diagram of a communication device.

FIG. 20 illustrates a computer-readable medium and a programmable control unit.

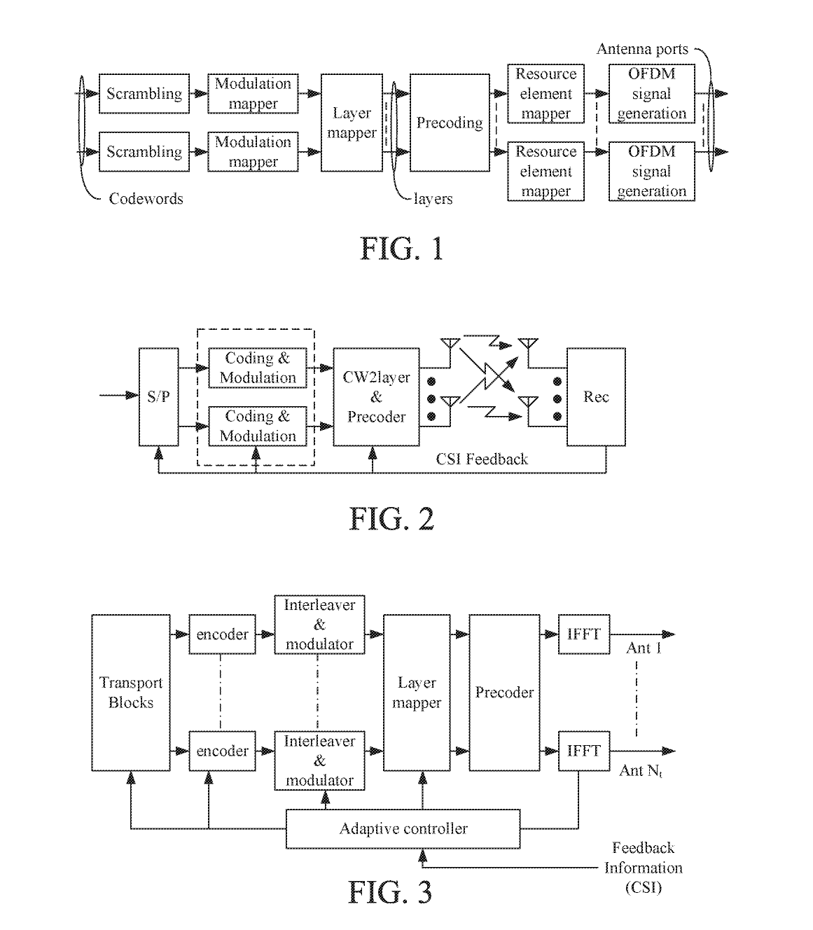

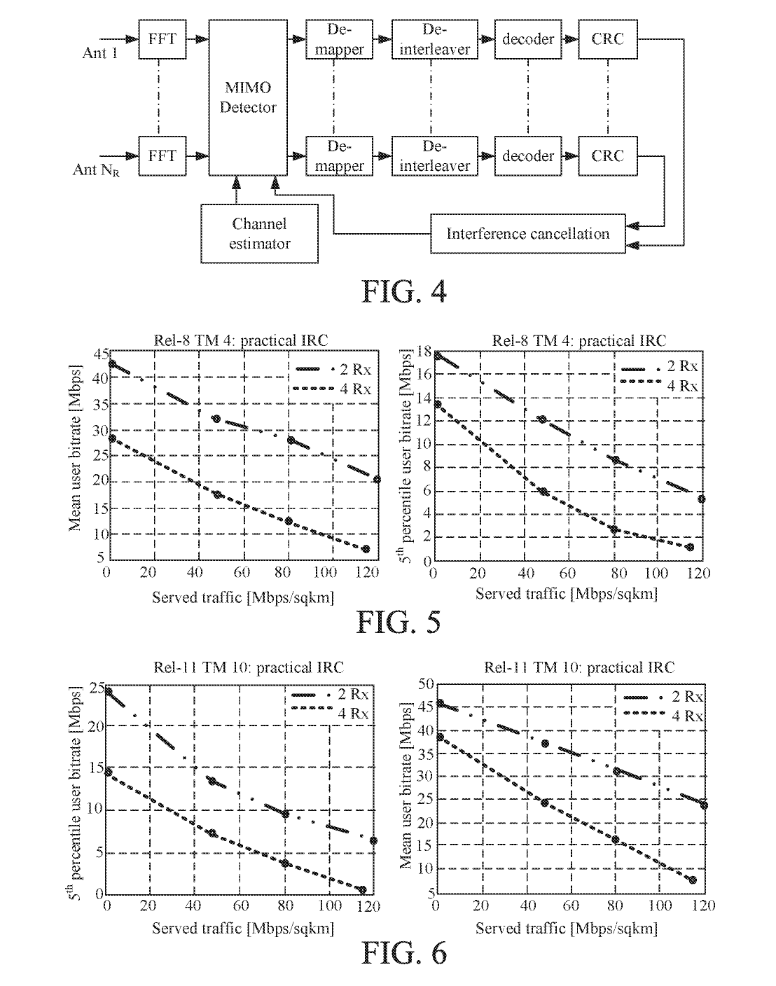

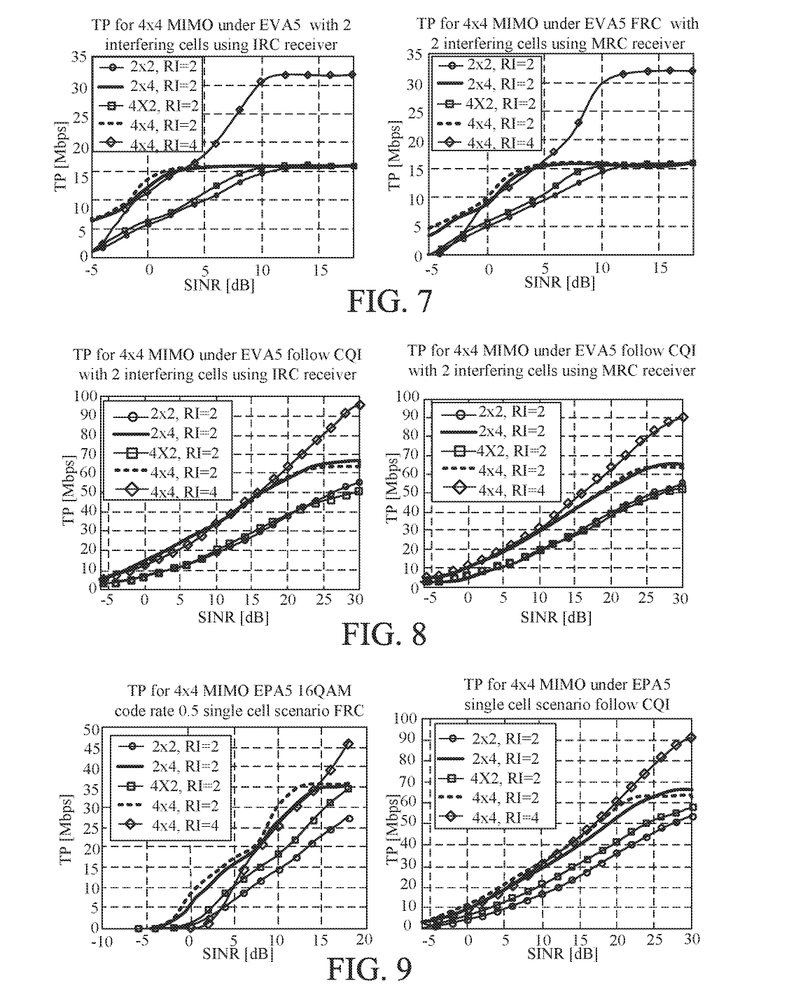

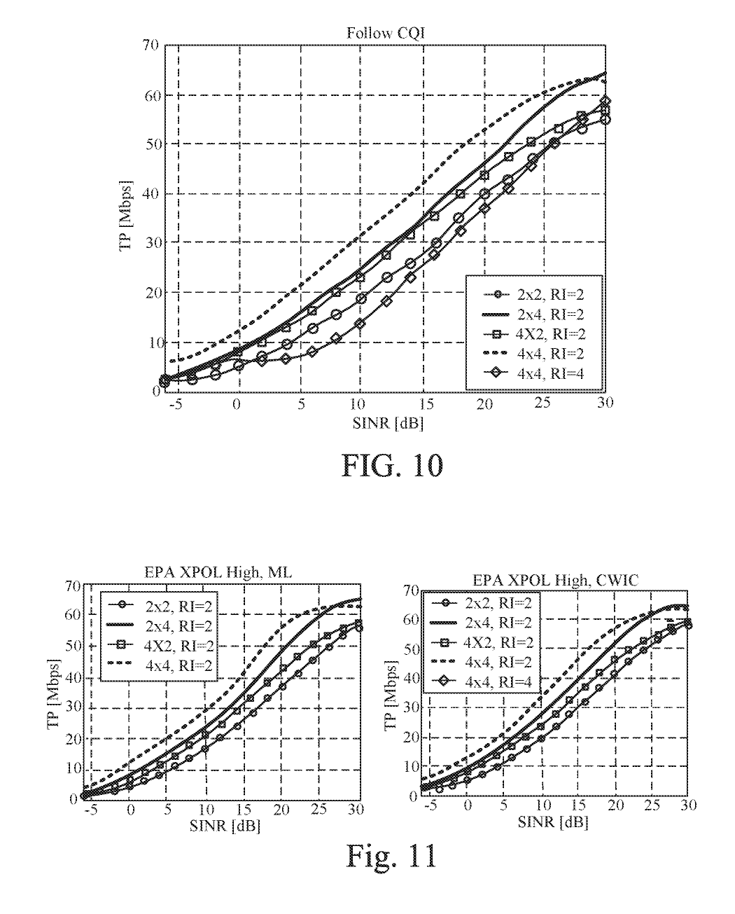

### DETAILED DESCRIPTION

The following description presents various embodiments of the disclosed subject matter. These embodiments are presented as teaching examples and should not be construed as limiting the scope of the disclosed subject matter.

In the following description, methods to select codeword-to-layer mapping in MIMO systems will be described. The inventors have recognized drawbacks with using a predetermined codeword-to-layer mapping scheme for a given number Q of layers and a given number P of codewords, for instance as defined in table 2 above. For instance, the inventors have recognized that for P≧2 and Q>P, it can be beneficial to have several different mapping schemes to choose from, for example depending on channel quality of the different layers.

One shortcoming of conventional codeword-to-layer mapping techniques is that when the UE has multiple Rx APs (larger than 2), the network node (e.g. Node B in HSPA or eNode B in LTE) can use high rank transmission, but the current way of codeword-to-layer mapping defined in 3GPP may be not optimized from a UE implementation and channel capacity point of view.

Also, with 4 Rx AP with more layers and high rank the impact from such factors as antenna configuration, correlation, power imbalance among Rx antennas to the CSI measurement can be very different compared to low rank. It has been observed with more than 1 layer, large SNR differences can be observed among layers due to such factors listed. The large difference can't be reflected by the 3 bits defined in 3GPP to reflect the differential CQI. The difference in SNR between the different layers, for more than two layers, might be large, which will make inefficient transmission if a codeword is mapped to layers with large SNR differences.

The inventors have recognized that by, for a given number of codewords and a given number of layers, providing several alternative codeword to layer mappings, it is possible to more efficiently use the available channel capacity, compared with if a single fixed codeword to layer mapping is used for a given number of codewords and a given number of layers.

The network node can for example be provided with additional CQI from a UE, which CQI represents the SNR level (or SINR level) for each layer, whereby it is facilitated to optimize, or improve, the codeword to layer mapping so that the overall system performance can be improved.

Some aspects described herein concern a method in a first multi-antenna UE. Such a method may comprise determining based on one or more criteria additional CQI information (parameter Z) for each layer by the first UE. Such a method may also comprise transmitting the determined information related to the parameter Z to a first network node and/or to a second network node.

Some aspects described herein concerns a method in a first network node and/or a second network node serving or managing a first UE with multi-antenna communication activated. Such a method may comprise obtaining information about the additional CQI information (parameter Z) for each layer from the first UE. Such a method may also comprise using the obtained information related to the parameter Z for one or more radio operational tasks e.g. optimizing CW to layer mapping in an adaptive way, adapting link adaptation, resource allocation scheduling, transmitting to other network nodes, for example
determining the transmission parameters such as modulation and code rate by using the obtained additional CQI information for each layer and/or
optimizing the CW to layer mapping in adaptive methods by using the obtained additional CQI information for each layer

The method may also include transmitting data and/or control information with the optimized CW to layer mapping, modulation, code rate and/or resource allocation. The transmission might also include signaling of the used CW to layer mapping if that information need to be updated in the first UE.

Advantages of some embodiments include:
The network node can use radio resources more efficiently while taking into consideration the optimized CW to layer mapping information from one or more UEs.
The network node can adapt link adaptation thereby minimizing the UE and system performance loss.
The network node can adapt the CQI reporting mode using the optimized CW to layer mapping information for one or more UEs.
By introducing this mechanism of reporting the optimized CW to layer mapping it gives more flexibility to the network to more easily change spatial multiplexing and tune beamforming to reach a higher system capacity.

### Generalization and Description of Scenario for MIMO

In some embodiments the non-limiting term radio network node or simply network node is used and it refers to any type of network node serving UE and/or connected to other network node or network element or any radio node from where UE receives signal. Examples of radio network nodes are Node B, base station (BS), multi-standard radio (MSR) radio node such as MSR BS, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used and it refers to any type of wireless device communicating with a radio network node in a cellular or mobile communication system. Examples of UE are target device, device to device (D2D) UE, machine type UE or UE capable of machine to machine (M2M) communication, PDA, iPAD, Tablet, mobile terminals, smart phone, laptop embedded equipped (LEE), laptop mounted equipment (LME), USB dongles etc.

The embodiments are described in particular for MIMO operation EUTRA/LTE. The embodiments are however applicable to any RAT or multi-RAT system where the UE operates using MIMO e.g. UTRA/HSPA, GSM/GERAN, Wi Fi, WLAN, WiMax, CDMA2000 etc.

The embodiments are applicable to single carrier as well as to multicarrier (MC) or carrier aggregation (CA) operation of the UE in conjunction with MIMO in which the UE is able to receive and/or transmit data to more than one serving cells using MIMO. The term carrier aggregation (CA) is also called (e.g. interchangeably called) “multi-carrier system”, “multi-cell operation”, “multi-carrier operation”, “multi-carrier” transmission and/or reception.

The receiver for mitigating the multi-antenna inter-stream interference can be based on different kinds of implementation e.g. maximum likelihood (ML) with full blow search, R-ML (reduced complex ML), code word interference cancellation (CWIC) and symbol level IC (SLIC) etc.

Method in UE of Determining and Indicating Additional CQI Information for Each Layer from UE Side

In an embodiment, a first UE determines additional CQI information for each layer by the first UE and indicate the associated information to a first network node and/or to a second network node. The steps performed in this embodiment by the first UE comprise:
Determining based on one or more criteria additional CQI information for each layer (Z) from the first UE;
Transmitting the determined information related to the parameter Z to a first network node and/or to a second network node.

The above steps are elaborated below:

### Determining the Additional CQI Information for Each Layer

In this step the first UE uses one or more criteria to determine the additional CQI information for each layer (Z) from the first UE instead of each codeword as the existing ones.

### CQI Estimation for Each Layer

In some embodiments, the determination of CQI is determined by

1. Obtaining the channel and interference estimates. The channel estimates is estimated from each antenna port to each receiver antenna. The interference is estimated per each receiver antenna.

2. From the channel and interference estimates an SINR for each layer is calculated. For linear receiver the SINR for layer k can for example be

S=HH^{H}+C−hh^{H}

SINRₖ=H^{H}S⁻¹H

where H is the channel, h is column k in H and C is the interference covariance matrix.

3. From the SINR for layer k a channel capacity and CQI can be derived by table look up previously stored in the terminal. There are several aspects for determine a CQI from a SINR, for example first a channel capacity can be calculated and then the capacity can be mapped to a CQI or there might be a SINR to CQI look up table that maps SINR directly to CQI.

For other receiver types than linear receiver the SINR, channel capacity and CQI may need to be determined by other ways. The reported additional CQI information for each layer can be interpreted as signal level estimated for each layer as indication of channel status for each layer in terms of SNR, SINR, CQI, Power level, Weights, etc.

### Reporting Mechanisms

In one aspect of this embodiment the first UE may report the said information proactively or autonomously whenever the first UE determines any change in the value of parameter, Z or periodically or whenever the first UE sends uplink feedback information (e.g. HARQ feedback, measurement report etc).

In another aspect of this embodiment the first UE may report the said information upon receiving a request from the first or the second network node to transmit the said information related to the value of parameter, Z. In yet another aspect of this embodiment the first UE may be requested by the first or the second network node to report the said information only if there is any change in the value of parameter for per carrier, Z, with respect to the previously determined value of the parameter for per carrier, Z.

The first UE may report the said information by using any of the following mechanisms:

In a first type of reporting mechanism, the first UE may transmit the said information in a higher layer signaling such as via RRC message to the first network node or to the second network node. Such information may also be reported in a MAC message.

In a second type of reporting mechanism, the first UE may also use the unused bits or code words or fields or control space or bit pattern or bit combinations (aka spared, reserved, redundant bits or code words or control space or bit pattern or bit combinations etc.) for indicating the information related to the determined parameter for per carrier, Z to the first or the second network node. Typically using this mechanism the first UE sends the determined information to the first network node (e.g. to the serving base station). The unused bits herein means any set of available bits in an uplink control channel that are not used for indicating the UE about any of uplink transmission parameters e.g. are not used for indicating uplink feedback information such as CSI related information or combined with uplink data and sent by uplink data channel.

Method in Network Node of Using Information about Additional CQI Information for Each Layer from UE Side

The network node receiving or obtaining the information about the additional CQI information for each layer (Z) from the first UE may use the said information for performing one or more radio operational or radio resource management tasks. The network node can use the received information Z directly on the CW to layer mapping step in an adaptive way as described in the following steps.

### Determining the Transmission Parameters

The network node can determine the transmission parameters such as modulation and code rate by using the obtained additional CQI information for each layer.

Other examples of radio operational or radio resource management tasks include:
Radio resource management: For example the first network node may use the information of Z into the adaptive scheduling to decide the resource allocation and MCS for the first UE.
Transmitting information to other network nodes: The first network node may also signal the received information to another network node. For example the first network node may send it to the second network node (such as by Node B to RNC over Iub interface in HSPA) and/or to even a third network node (e.g. neighboring base station such as by serving eNode B to neighboring eNode over X interface in LTE) etc. The receiving network node may use the received information for one or more radio tasks. For example the RNC may adapt or modify one or more UEs (first, second or third UEs) with the correlation information provided by the UEs.

### Method of Determining the Desired Number of CW for First UE Based on Existing CW to Layer Mapping

There are circumstances where only one codeword or less number of layers may be desired. For example where there are big difference on signal levels from 2 codewords due to the reason one of the codewords may experience very bad channel condition, some of the layers with reported CQI information from value Z gives indication of very low SNR on certain layers it would be better to only use the layers with good conditions.

Under Carrier Aggregation (CA) scenarios when several DL carriers are used but there is only one UL carrier to transmit ACK/NACK feedback. For this case it can be good use one codeword covering several layers to limit the UL signaling.

Another scenario is under TDD bundling case where there are heavy DL subframes, e.g. UL/DL configuration 5 there is only one UL subframe to transmit ACK/NACK feedback. In such scenarios system performance could be more robust if only one codeword is used for several layers.

Also depending on reported RI from first UE it gives indication on number of layers are desired from the first UE which could help determine the number of layers from network node.

The first UE may use any combination of the criteria mentioned above to decide whether to restrict the number codeword or layers to be used in the system.

In yet another embodiment the number of CWs can be determined by distinguish groups of layers that have similar SNR/CQI values, i.e. are within a predefined range such as within maximum distance is e.g. 4 dB. Each group of layers is then coded and transmitted with same modulation and coding scheme. The number of CWs should be kept low to limit the signaling.

### Method of Determining the Desired Number of CW for First UE Based on Adaptive CW to Layer Mapping

With multiple codewords to map to different layers there are other mapping rules than the existing ones from Table 2. For example with 2 code words mapped to 4 layers in Table 5 the first row is the existing one (Mode 2-2) and the 2^{nd} row (Mode 1-3) is a new rule where the 1^{st} codeword is mapped to 1^{st} layer while the 2^{nd} codeword is mapped to the rest layers. The new rule gives the possibility for the UE to have a smaller buffer size to decode the first codeword instead of 2 as the legacy way, thus it can dump the decoded data faster after 1^{st} codeword is decoded, compared to a Mode 2-2 CW to layer mapping. Another advantage of Mode 1-3 is the CQI estimation of the first codeword is always more reflecting the real channel condition than the Mode 2-2 case with 2 layers mapped in one codeword with one CQI reported. For example depending on the reported CQI information (Z) from each layer from the first UE the network can choose the good condition layer with better CQI to be mapped from the first codeword.

TABLE 5
Adaptive CW to layer mapping

| Number of | Number of | Codeword-to-layer mapping | | |
|---|---|---|---|---|
| layers | codewords | i = 0, 1, . . . M_{symb}^{layer} − 1 | | Mode |
| 4 | 2 | x⁽⁰⁾ (i) = d⁽⁰⁾ (2i) | M_{symb}^{layer} = | |
| | | x⁽¹⁾ (i) =d⁽⁰⁾ (2i + 1) | M_{symb}⁽⁰⁾/2 = | 2-2 |
| | | x⁽²⁾ (i) =d⁽¹⁾ (2i) | M_{symb}⁽¹⁾/2 | |
| | | x⁽³⁾ (i) =d⁽¹⁾ (2i + 1) | | |
| 4 | 2 | x⁽⁰⁾ (i) = d⁽⁰⁾ (i) | M_{symb}^{layer} = | |
| | | x⁽¹⁾ (i) = d⁽¹⁾ (3i) | M_{symb}⁽⁰⁾ = | 1-3 |
| | | x⁽²⁾ (i) = d⁽¹⁾ (3i + 1) | M_{symb}⁽¹⁾/3 | |
| | | x⁽³⁾ (i) = d⁽¹⁾ (3i + 2) | | |

Another more flexible method of CW to layer mapping can be also used for information as shown in Table 6 where there are 3 layers mapped to 2 codewords as an example. There are 2 basic mapping mode as Mode 1-2 and Mode 2-1 where Mode 1-2 maps layer to the first codeword and 2 layers to the second codeword while Mode 2-1 maps 2 layers to the first codeword and 1 layer to the second codeword. Within each Mode there can be flexible combinations of different layers which can depend on the reported CQI from each layers from first UE. For example if layer 0 and layer 1 have the similar CQI then these 2 layers should be combined into one codeword as in either Mode 1-2c or Mode 2-1a.

TABLE 6
Extended adaptive CW to layer
mapping with 3 layers and 2 codewords

| Number | Number | | | |
|---|---|---|---|---|
| of | of | Codeword-to-layer mapping | | |
| layers | codewords | i = 0, 1, . . . , M_{symb}^{layer} − 1 | | Mode |
| 3 | 2 | x⁽⁰⁾ (i) = d⁽⁰⁾ (i) | M_{symb}^{layer} = | 1-2a |
| | | x⁽¹⁾ (i) = d⁽¹⁾ (2i) | M_{symb}⁽⁰⁾ = M_{symb}⁽¹⁾/2 | |
| | | x⁽²⁾ (i) = d⁽¹⁾ (2i + 1) | | |
| 3 | 2 | x⁽¹⁾ (i) = d⁽⁰⁾ (i) | M_{symb}^{layer} = | 1-2b |
| | | x⁽⁰⁾ (i) = d⁽¹⁾ (2i) | M_{symb}⁽⁰⁾ = | |
| | | x⁽²⁾ (i) = d⁽¹⁾ (2i + 1) | M_{symb}⁽¹⁾/2 | |
| 3 | 2 | x⁽²⁾ (i) = d⁽⁰⁾ (i) | M_{symb}^{layer} = | 1-2c |
| | | x⁽⁰⁾ (i) = d⁽¹⁾ (2i) | M_{symb}⁽⁰⁾ = | |
| | | x⁽¹⁾ (i) = d⁽¹⁾ (2i + 1) | M_{symb}⁽¹⁾/2 | |
| 3 | 2 | x⁽⁰⁾ (i) = d⁽⁰⁾ (2i) | M_{symb}^{layer} = | 2-1a |
| | | x⁽¹⁾ (i) = d⁽⁰⁾ (2i + 1) | M_{symb}⁽⁰⁾/2 = M_{symb}⁽¹⁾ | |
| | | x⁽²⁾ (i) = d⁽¹⁾ (i) | | |
| 3 | 2 | x⁽⁰⁾ (i) = d⁽⁰⁾ (2i) | M_{symb}^{layer} = | 2-1b |
| | | x⁽²⁾ (i) = d⁽⁰⁾ (2i + 1) | M_{symb}⁽⁰⁾/2 = M_{symb}⁽¹⁾ | |
| | | x⁽¹⁾ (i) = d⁽¹⁾ (i) | | |
| 3 | 2 | x⁽¹⁾ (i) = d⁽⁰⁾ (2i) | M_{symb}^{layer} = | 2-1c |
| | | x⁽²⁾ (i) = d⁽⁰⁾ (2i + 1) | M_{symb}⁽⁰⁾/2 = M_{symb}⁽¹⁾ | |
| | | x⁽⁰⁾ (i) = d⁽¹⁾ (i) | | |

Transmitting Data and/or Control Information with the Optimized CW to Layer Mapping, Modulation and Code Rate and Resource Allocation

The network node have determined optimized CW to layer mapping, modulation and code rate and resource allocation for the first UE. It will then use that for transmission of data and/or control information back to the first UE with the determined parameters.

The transmission to the first UE might also need to include the optimized CW to layer mapping, either as an index refereeing to a predefined table or as vectors, where each vector indicates which layers that are associated with the CW. The network node might also exclude such information if the UE can determine the CW to layer mapping in other ways, for example by assuming that the same CW to layer mapping is used as in previous transmission or by blindly test the possible CW to layer mappings.

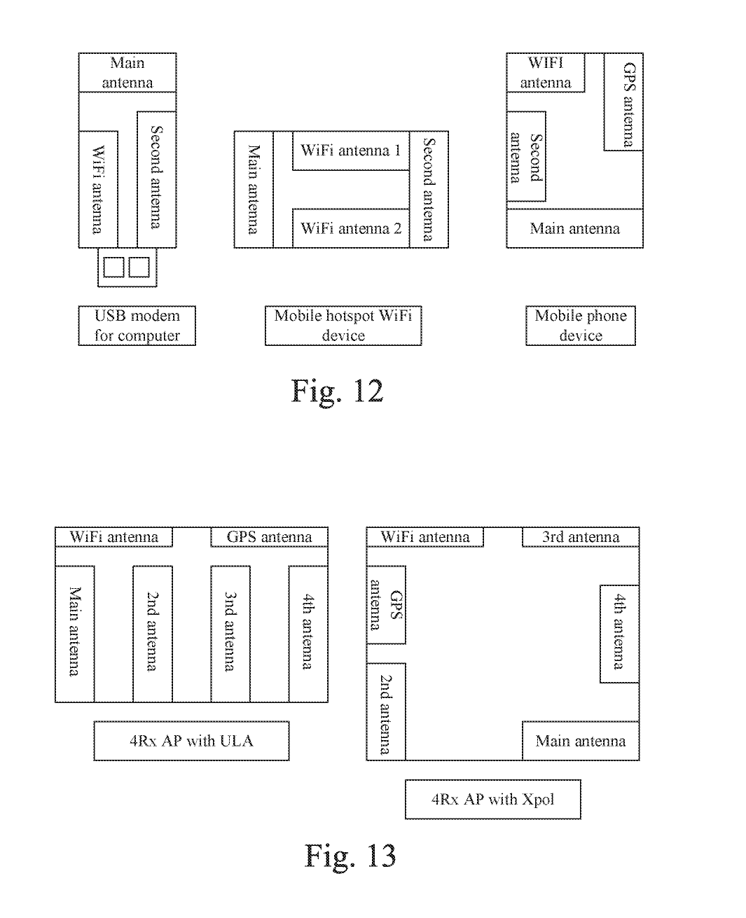

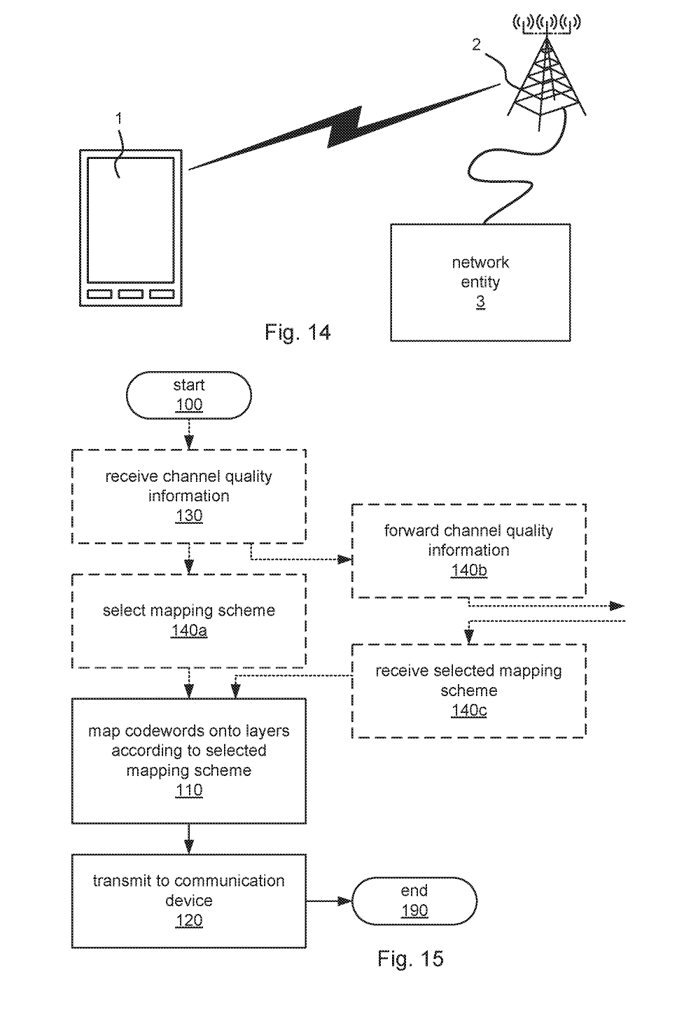

In the following description, some embodiments are described with reference to block diagrams and flowcharts. FIG. 14 illustrates schematically a communication environment wherein embodiments described herein can be employed. A communication device 1 is in wireless communication with a network node 2 of a cellular communication system. The communication device is illustrated in FIG. 14 as a mobile telephone, but may be any kind of communication device, or user equipment “UE”, capable of communication with a cellular communication network, such as a machine-type communication (MTC) device or any other device comprising a cellular modem, such as any of the devices depicted in FIG. 12. Furthermore, the network node 2 may be any kind of network node of a cellular communication network, such as a radio base station, NodeB, eNodeB, pico base station, femto base station, etc. As depicted in FIG. 14, the network node 2 may also be in contact with other network entities 3 of the cellular communication network. The network entity 3 may e.g. be another network node, a server, a network controller, etc. Embodiments are described below in the context where the network node 2 should transmit MIMO transmissions to the communication device 1 using P codewords mapped onto Q MIMO layers. The network node 2 and communication device 1 may be capable of MIMO communication for many different combinations of P and Q. The description below concerns a particular case, or situation, wherein the network node 2 and communication device 1 have been configured to communicate with particular selected values of P and Q, for which P is an integer≧2 and Q is an integer>P. For this particular combination of P and Q considered in the description below, there are a plurality of available mapping schemes of codewords to MIMO layers to select from, for example as in the example with P=2 and Q=4 illustrated with table 5 above, or as in the example with P=2 and Q=3 illustrated with table 6 above. In some embodiments, wherein P=2 and Q≧3, such as in the LTE examples provided above.

FIG. 15 is a flowchart of a method in the network node 2 for providing MIMO transmissions to the communication device 1, said MIMO transmissions using P code words mapped onto Q MIMO layers, where P≧2 and Q>P as outlined above. Operation of the method is started in step 100. The method comprises mapping the code words for transmission to the communication device onto the MIMO layers according to a selected mapping scheme that has been selected among a plurality of available mapping schemes available for use for MIMO transmission of P code words over Q MIMO layers in the cellular communications system. This mapping is performed in step 110. The MIMO transmission to the communication device 1 is performed in step 120. The operation is then ended in step 190. The method may then be repeated. Having a plurality of different mapping schemes to select from (for a particular combination of P and Q) facilitates improved utilization of the communication capacity (for the particular combination of P and Q) compared with having a fixed predetermined mapping (for the particular combination of P and Q), which is e.g. the case in the current LTE standard.

The actual selection of mapping scheme may be based on channel quality information for each of the layers. Such channel quality information may e.g. indicate a signal-to-noise ratio (SNR) or signal-to-interference-and-noise ratio (SINR) for each of the layers. Notably, the CQI reporting in the present LTE standard does not provide enough information to indicate such channel quality information for each of the layers.

The selection of mapping scheme among the plurality of available mapping schemes may e.g. be performed using a table-based approach. Simulations and/or measurements may be used on beforehand determine which mapping scheme provides the best result for different sets of channel quality information values. This information may be stored in a look-up table, and the mapping scheme may be selected using the channel quality information as input to the look-up table.

The method in the network node 2 may include selecting (in the network node) the selected mapping scheme based on said channel quality information for each of the layers, as illustrated by step 140a in FIG. 15. The method may also include receiving the channel quality information for each layer from the communication device 1, as illustrated with step 130 in FIG. 15.

Alternatively, the method may include receiving control information indicating the selected mapping scheme from another network entity (e.g. 3 in FIG. 14), which has selected the selected mapping scheme, as illustrated with step 140c in FIG. 15. For example, the method may include receiving the channel quality information for each layer from the communication device 2 (step 130), forwarding the channel quality information to the other network entity 3 (step 140b), which is to perform the selection of the mapping scheme, receiving control information indicating the selected mapping scheme from the other network entity 3 (step 140c).

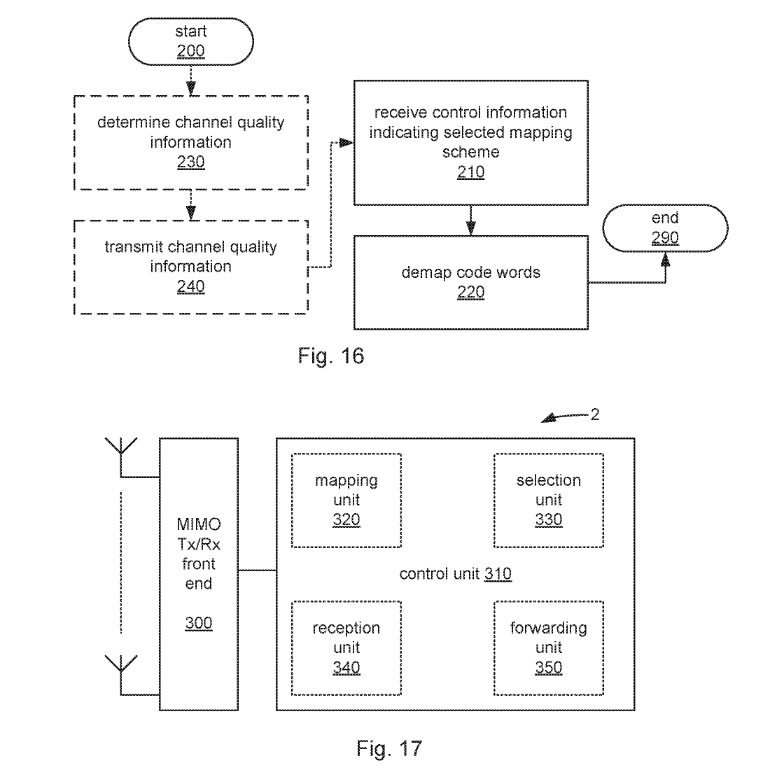

FIG. 16 is a flowchart of a method in the communication device 1 for reception of MIMO transmissions from the network node 2 to the communication device, said MIMO transmissions using P code words mapped onto Q MIMO layers where P≧2 and Q>P. Operation of the method is started in step 200. The method comprises receiving (for example from the network node 2) control information indicating a selected mapping scheme that has been selected among a plurality of available mapping schemes available for use for MIMO transmission of P code words over Q MIMO layers in the cellular communications system. This is illustrated with step 210. Furthermore, the method comprises demapping code words from received MIMO layers according to the selected mapping scheme. This is illustrated with step 220. The operation is then ended in step 290. The method may then be repeated when a next reception is made.

The method in the communication device 1 may include determining the above-mentioned channel quality information for each of the layers (step 230). This may for example include making SINR or SNR measurements for each of the layers. The method in the communication device 1 may also include transmitting the channel quality information to the network node 1 to facilitate selection of the mapping scheme (step 240).

FIG. 17 is a simplified block diagram of the network node 2. As illustrated in FIG. 17, the network node 2 may comprise a MIMO transceiver front end 300 for sending and receiving radio signals to and from communication devices (such as 1) in the cellular communications system. Furthermore, the network node comprises a control unit 310 adapted to map the code words for transmission to the communication device onto the MIMO layers according to a selected mapping scheme that has been selected among a plurality of available mapping schemes available for use for MIMO transmission of P code words over Q MIMO layers in the cellular communications system. As illustrated in FIG. 17, the control unit 310 may comprise a mapping unit 320 adapted to map the code words for transmission to the communication device onto the MIMO layers according to the selected mapping scheme. The control unit 310 may be adapted to select the selected mapping scheme based on said channel quality information for each of the layers. As illustrated in FIG. 17, the control unit 310 may comprise a selection unit 320 adapted to select the selected mapping scheme.

The control unit 310 may be adapted to receive the channel quality information for each layer from the communication device 1. As illustrated in FIG. 17, the control unit 310 may comprise a reception unit 340 adapted to receive the channel quality information for each layer from the communication device 1.

The control unit 310 may be adapted to receive control information indicating the selected mapping scheme from another network entity 3, which has selected the selected mapping scheme. The reception unit 340 may be adapted to receive the control information indicating the selected mapping scheme from the other network entity 3.

The control unit 310 may be adapted to forward the channel quality information to the other network entity 3. As illustrated in FIG. 17, the control unit 310 may comprise a forwarding unit 350 adapted to forward the channel quality information to the other network entity 3.

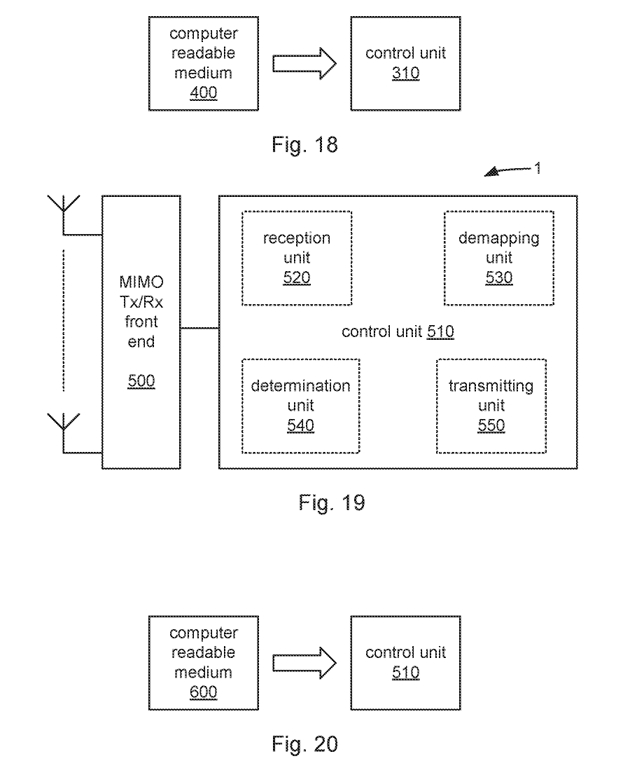

In some embodiments, the control unit 310 may be implemented as a dedicated application-specific hardware unit. Alternatively, said control unit 310, or parts thereof, may be implemented with programmable and/or configurable hardware units, such as but not limited to one or more field-programmable gate arrays (FPGAs), processors, or microcontrollers. Thus, the control unit 310 may be a programmable control unit. Hence, embodiments of the method illustrated in FIG. 15 may be embedded in a computer program product, which enables implementation of the method and functions of the network node 2 described herein, e.g. the embodiments of the methods described with reference to FIG. 15. Accordingly, in some embodiments, there is provided a computer program product comprising computer program code for executing the method of the network node 2 described above in the context of FIG. 15 when said computer program code is executed by the programmable control unit 310 of the network node 2. The computer program product may comprise program code which is stored on a computer readable medium 400, as illustrated in FIG. 18, which can be loaded and executed by said programmable control unit 310.

FIG. 19 is a simplified block diagram of the communication device 1. As illustrated in FIG. 19, the communication device 1 may comprise a MIMO transceiver front end 500 for sending and receiving radio signals to and from network nodes (such as 2) of the cellular communications system. Furthermore, the communication device comprises a control unit 510 adapted to receive (for example from the network node 2) control information indicating a selected mapping scheme that has been selected among a plurality of available mapping schemes available for use for MIMO transmission of P code words over Q MIMO layers in the cellular communications system. As illustrated in FIG. 19, the control unit 510 may comprise a reception unit 520 adapted to receive the control information indicating the selected mapping scheme. Moreover, the control unit 510 is adapted to demap code words from received MIMO layers according to the selected mapping scheme. As illustrated in FIG. 19, the control unit 510 may comprise a demapping unit 530 adapted to demap the code words from the received MIMO layers according to the selected mapping scheme.

The control unit 510 may be adapted to determine the above mentioned channel quality information for each of the layers and transmit the channel quality information to the network node to facilitate selection of the mapping scheme. As illustrated in FIG. 19, the control unit 510 may comprise a determination unit 540 adapted to determine the above mentioned channel quality information for each of the layers. As also illustrated in FIG. 19, the control unit 510 may comprise a transmitting unit 550 adapted to transmit the channel quality information to the network node to facilitate selection of the mapping scheme.

In some embodiments, the control unit 510 may be implemented as a dedicated application-specific hardware unit. Alternatively, said control unit 510, or parts thereof, may be implemented with programmable and/or configurable hardware units, such as but not limited to one or more field-programmable gate arrays (FPGAs), processors, or microcontrollers. Thus, the control unit 510 may be a programmable control unit. Hence, embodiments of the method illustrated in FIG. 16 may be embedded in a computer program product, which enables implementation of the method and functions of the communication device 1 described herein, e.g. the embodiments of the methods described with reference to FIG. 16. Accordingly, in some embodiments, there is provided a computer program product comprising computer program code for executing the method of the communication device 1 described above in the context of FIG. 16 when said computer program code is executed by the programmable control unit 510 of the communication device 1. The computer program product may comprise program code which is stored on a computer readable medium 600, as illustrated in FIG. 20, which can be loaded and executed by said programmable control unit 510.

The mentioning of Q>P and P≧2 is used herein to indicate that the disclosure concerns how the codeword-to-layer mapping is to be performed for these particular values of P and Q, but does not limit the operation of the communication device or the network node to these values. The communication device and network node may be capable of communicating with other values of P and Q as well, such as Q=P and/or P=1, e.g. using well established and standardized procedures.

The disclosed subject matter has been described above with reference to specific embodiments. However, other embodiments than the above described are possible within the scope of the disclosed subject matter. Different method steps than those described above, performing the method by hardware or software, may be provided within the scope of the described subject matter. The different features and steps of the embodiments may be combined in other combinations than those described.

1. A method in a network node of a cellular communications system for providing multiple-input multiple-output, MIMO, transmissions to a communication device in the cellular communications system, said MIMO transmissions using P code words mapped onto Q MIMO layers where P≧2 and Q>P, the method comprising
mapping the code words for transmission to the communication device onto the MIMO layers according to a selected mapping scheme that has been selected among a plurality of available mapping schemes available for use for MIMO transmission of P code words over Q MIMO layers in the cellular communications system.

2. The method according to claim 1, wherein the selected mapping scheme is selected based on channel quality information for each of the layers.

3. The method according to claim 2, comprising
selecting the selected mapping scheme based on said channel quality information for each of the layers.

4. The method according to claim 2, comprising
receiving the channel quality information for each layer from the communication device.

5. The method according to claim 1, comprising
receiving control information indicating the selected mapping scheme from another network entity, which has selected the selected mapping scheme.

6. The method according to claim 2, comprising
receiving the channel quality information for each layer from the communication device;
forwarding the channel quality information to another network entity, which is to perform the selection of the mapping scheme; and
receiving control information indicating the selected mapping scheme from the other network entity.

7. The method according to claim 2, wherein the channel quality information is indicative of a signal-to-interference-and-noise ratio, SINR, for each layer.

8. The method according to claim 1, wherein P=2 and Q≧4.

9. A method in a communication device of a cellular communications network for reception of multiple-input multiple-output, MIMO, transmissions from a network node in the cellular communications system to the communication device, said MIMO transmissions using P code words mapped onto Q MIMO layers where P≧2 and Q>P, the method comprising
receiving control information indicating a selected mapping scheme that has been selected among a plurality of available mapping schemes available for use for MIMO transmission of P code words over Q MIMO layers in the cellular communications system; and
demapping code words from received MIMO layers according to the selected mapping scheme.

10. The method according to claim 9, wherein the selected mapping scheme is selected based on channel quality information for each of the layers.

11. The method according to claim 10, comprising
determining the channel quality information; and
transmitting the channel quality information to the network node to facilitate selection of the mapping scheme.

12. The method according to claim 10, wherein the channel quality information is indicative of a signal-to-interference-and-noise ratio, SINR, for each layer.

13. A network node of a cellular communications system for providing multiple-input multiple-output, MIMO, transmissions to a communication device in the cellular communications system, said MIMO transmissions using P code words mapped onto Q MIMO layers where P≧2 and Q>P, the network node comprising
a control unit adapted to map the code words for transmission to the communication device onto the MIMO layers according to a selected mapping scheme that has been selected among a plurality of available mapping schemes available for use for MIMO transmission of P code words over Q MIMO layers in the cellular communications system.

14. The network node according to claim 13, wherein the selected mapping scheme is selected based on channel quality information for each of the layers.

15. The network node according to claim 14, wherein the control unit is adapted to select the selected mapping scheme based on said channel quality information for each of the layers.

16. The network node according to claim 14, wherein the control unit is adapted to receive the channel quality information for each layer from the communication device.

17. The network node according to claim 13, wherein the control unit is adapted to receive control information indicating the selected mapping scheme from another network entity, which has selected the selected mapping scheme.

18. The network node according to claim 14, wherein the control unit is adapted to receive the channel quality information for each layer from the communication device;
forward the channel quality information to another network entity, which is to perform the selection of the mapping scheme; and
receive control information indicating the selected mapping scheme from the other network entity.

19. The network node according to claim 14, wherein the channel quality information is indicative of a signal-to-interference-and-noise ratio (SINR) for each of the layers.

20. The network node according to claim 13, wherein P=2 and Q≧4.

21. A communication device for reception of multiple-input multiple-output, MIMO, transmissions from a network node in a cellular communications system to the communication device, said MIMO transmissions using P code words mapped onto Q MIMO layers where P≧2 and Q>P, the communication device comprising a control unit adapted to
receive control information indicating a selected mapping scheme that has been selected among a plurality of available mapping schemes available for use for MIMO transmission of P code words over Q MIMO layers in the cellular communications system; and
demap code words from received MIMO layers according to the selected mapping scheme.

22. The communication device according to claim 21, wherein the selected mapping scheme is selected based on channel quality information for each of the layers.

23. The communication device according to claim 22, wherein the control unit is adapted to
determine the channel quality information; and
transmit the channel quality information to the network node to facilitate selection of the mapping scheme.

24. The communication device according to claim 22, wherein the channel quality information is indicative of a signal-to-interference-and-noise ratio (SINR) for each of the layers.

25. A computer program product comprising computer program code for executing the method according to claim 1 when said computer program code is executed by a programmable control unit of the network node.

26. A computer program product comprising computer program code for executing the method according to claim 9 when said computer program code is executed by a programmable control unit of the communication device.

27. A computer readable medium having stored thereon a computer program product comprising computer program code for executing the method according to claim 1 when said computer program code is executed by a programmable control unit of the network node.

28. A computer readable medium having stored thereon a computer program product comprising computer program code for executing the method according to claim 9 when said computer program code is executed by a programmable control unit of the communication device.
